(19) United States
(12) Patent Application Publication
(10) Pub. No.: US 2020/0176019 A1
(43) Pub. Date: Jun. 4, 2020

(54) METHOD AND SYSTEM FOR RECOGNIZING EMOTION DURING CALL AND UTILIZING RECOGNIZED EMOTION

(71) Applicant: LINE Corporation, Tokyo (JP)

(72) Inventors: Jungjun Park, Seongnam-si (KR); Dongwon Lee, Seongnam-si (KR); Jongjin Cho, Seongnam-si (KR); In Won Cho, Seongnam-si (KR)

(73) Assignee: LINE Corporation, Tokyo (JP)

(21) Appl. No.: 16/780,246

(22) Filed: Feb. 3, 2020

Related U.S. Application Data
(63) Continuation of application No. PCT/KR2017/008557, filed on Aug. 8, 2017.

(51) Int. Cl. G10L 25/63

(52) U.S. Cl. CPC G10L 25/63

(57) ABSTRACT

Disclosed are a method and a system for recognizing an emotion during a call and utilizing the recognized emotion. An emotion-based call content providing method includes recognizing an emotion from call details during a call between a user and a counterpart, and storing at least a portion of the call details and providing the same as content related to the call based on the recognized emotion.

### CROSS-REFERENCE TO RELATED APPLICATIONS

This U.S. non-provisional application is a continuation application of, and claims the benefit of priority under 35 U.S.C. § 365(c) from International Application PCT/KR2017/008557, which has an International filing date of Aug. 8, 2017, the entire contents of which are incorporated herein by reference in their entirety.

### BACKGROUND

### Technical Field

One or more example embodiments relate to methods, systems, apparatuses, and/or non-transitory computer readable media for recognizing an emotion during a call and using the recognized emotion.

### Related Art

Transmission and recognition of emotions is very important in communication for accurate communication between a person and a machine as well as for communication between persons.

Communication between people recognizes or communicates emotions through various elements, such as voice, gestures, facial expressions, individually or in combination.

Currently, with the development of Internet of things (IoT) technology, communication between a person and a machine or transmission of emotions becomes important. To this end, technology for recognizing emotions of a person based on facial expressions, voice, biosignals, etc., is being used.

For example, an emotion may be recognized by applying a pattern recognition algorithm to a biosignal of a.

### SUMMARY

Some example embodiments provide methods and/or systems that may recognize an emotion during a call and use the recognized emotion in the call using an Internet telephone, that is, a voice over Internet protocol (VoIP).

Some example embodiments provide methods and/or systems that may provide a main scene based on emotions recognized during a call when the call is terminated.

Some example embodiments provide methods and/or systems that may display a representative emotion in call details based on emotions recognized during a call.

According to an example embodiment, a computer-implemented emotion-based call content providing method includes recognizing an emotion from call details during a call between a user and a counterpart, storing at least a portion of the call details, and providing the at least a portion of the call details as first content related to the call based on the recognized emotion.

The recognizing may include recognizing the emotion using at least one of a video and a voice exchanged between the user and the counterpart.

The recognizing may include recognizing the emotion about at least one of the user and the counterpart from the call details.

The recognizing may include recognizing an emotion intensity for each section of the call, and the providing may include storing, as highlight content, call details of a specific section from which a specific emotion with a highest intensity is recognized among the entire sections of the call.

The providing may include providing the highlight content through an interface screen associated with the call.

The providing may include providing a function of sharing the highlight content with another user.

The emotion-based call content providing method may further include selecting a representative emotion based on at least one of an emotion type and an intensity of the recognized emotion and providing second content corresponding to the representative emotion.

The providing second the content corresponding to the representative emotion may include selecting a first emotion corresponding to a highest appearance frequency or a highest emotion intensity as the representative emotion, or summing values of emotion intensity for each emotion type and selecting a second emotion having a largest summed value as the representative emotion.

The providing second content corresponding to the representative emotion may include displaying an icon representing the representative emotion through an interface screen associated with the call.

The emotion-based call content providing method may further include calculating an emotion ranking for each counterpart by accumulating the recognized emotion therefor, and providing a counterpart list including identifications of counterparts and emotion rankings associated therewith.

The providing a counterpart list may include calculating the emotion ranking for each counterpart by summing values of an intensity of emotion corresponding to an emotion type among a plurality of emotions recognized with respect to the call.

The providing a counterpart list may include calculating the emotion ranking for each counterpart with respect to each emotion type and providing the counterpart list according to the emotion ranking of a specific emotion type selected based on a user request.

According to an example embodiment, a non-transitory computer-readable storage medium storing a computer program, when executed by a computer, to cause the computer to perform an emotion-based call content providing method. The emotion-based call content providing method includes recognizing an emotion from call details during a call between a user and a counterpart, storing at least a portion of the call details, and providing the at least a portion of the call details as content related to the call based on the recognized emotion.

According to an example embodiment, a computer-implemented emotion-based call content providing system includes at least one processor configured to execute computer-readable instructions. The at least one processor is configured to recognize an emotion from call details during a call between a user and a counterpart, store at least a portion of the call details, and provide the at least a portion of the call details as content related to the call based on the recognized emotion.

According to some example embodiments, it is possible to recognize an emotion during a call in the call using an Internet telephone, that is, a voice over Internet protocol (VoIP), and to generate and use content related to the call based on the recognized emotion.

According to some example embodiments, it is possible to recognize an emotion during a call in the call using an Internet telephone, that is, a VoIP and to provide various user interfaces (UIs) or fun elements associated with the call based on the recognized emotions.

### BRIEF DESCRIPTION OF DRAWINGS

FIG. 1 is a diagram illustrating an example of a computer system according to at least one example embodiment.

FIG. 2 is a diagram illustrating an example of components includable in a processor of a computer system according to at least one example embodiment.

FIG. 3 is a flowchart illustrating an example of an emotion-based call content providing method performed by a computer system according to at least one example embodiment.

FIG. 4 is a flowchart illustrating an example of a process of recognizing an emotion from a voice according to at least one example embodiment.

FIG. 5 is a flowchart illustrating an example of a process of recognizing an emotion from a video according to at least one example embodiment.

FIGS. 6 to 9 illustrate examples of describing a process of providing highlight content according to at least one example embodiment.

FIGS. 10 and 11 illustrate examples of describing a process of providing content corresponding to a representative emotion according to at least one example embodiment.

FIG. 12 illustrates an example of describing a process of providing a counterpart list to which emotion rankings are applied according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for recognizing an emotion during a call and using the recognized emotion.

The example embodiments including the disclosures herein may recognize an emotion during a call, may generate and provide content related to the call based on the recognized emotion or may provide various user interfaces (UIs) or fun elements associated with the call, and accordingly, may achieve many advantages in terms of fun, variety, efficiency, and the like.

The term “call” used herein may inclusively indicate a voice call using a voice with a counterpart and a video call using a video and a voice with the counterpart. For example, the call may indicate an internet telephone, that is, a voice over Internet protocol (VoIP) that may convert a voice and/or video to a digital packet and thereby transmit the same over a network using an IP address.

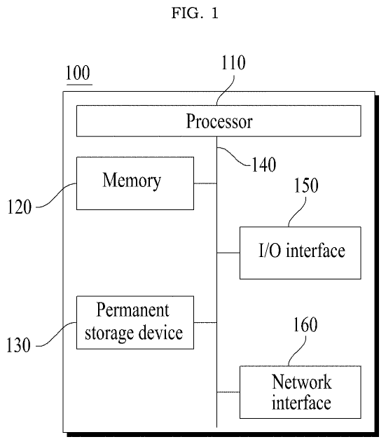

FIG. 1 is a diagram illustrating an example of a computer system according to at least one example embodiment.

An emotion-based call content providing system according to example embodiments may be configured through a computer system 100 of FIG. 1. Referring to FIG. 1, the computer system 100 may include a processor 110, a memory 120, a permanent storage device 130, a bus 140, an input/output (I/O) interface 150, and a network interface 160 as components for performing an emotion-based call content providing method.

The processor 110 may include an apparatus or circuitry capable of processing a sequence of instructions or may be a portion thereof. The processor 110 may include, for example, a computer processor, a processor included in a mobile device or another electronic device, and/or a digital processor. The processor 110 may be included in, for example, a server computing device, a server computer, a series of server computers, a server farm, a cloud computer, a content platform, a mobile computing device, a smartphone, a tablet, a set-top box, and the like. The processor 110 may connect to the memory 120 through the bus 140. The processor 110 may include processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The memory 120 may include a volatile memory, a permanent memory, a virtual memory, or other memories configured to store information used by the computer system 100 or output from the computer system 100. For example, the memory 120 may include a random access memory (RAM) and/or a dynamic RAM (DRAM). The memory 120 may be used to store random information, for example, state information of the computer system 100. The memory 120 may be used to store instructions of the computer system 100 that includes instructions for controlling, for example, a call function. The computer system 100 may include at least one processor 110.

The bus 140 may include a structure based on communication that enables an interaction between various components of the computer system 100. The bus 140 may convey data between components of the computer system 100 (e.g., between the processor 110 and the memory 120). The bus 140 may include a wireless and/or wired communication medium between the components of the computer system 100 and may include parallel, serial, or other topology arrangements.

The permanent storage device 130 may include components, for example, a memory or another permanent storage device used by the computer system 100 to store data during a desired (or alternatively, predetermined) extended period (compared to, for example, the memory 120). The permanent storage device 130 may include a non-volatile main memory as used by the processor 110 in the computer system 100. For example, the permanent storage device 130 may include a flash memory, a hard disc, an optical disc, or another computer-readable medium.

The I/O interface 150 may include a keyboard, a mouse, a microphone, a camera, a display, or interfaces for another input or output device. Constituent instructions and/or input associated with a call function may be received through the I/O interface 150.

The network interface 160 may include at least one interface for networks, for example, a local area network (LAN) and the Internet. The network interface 160 may include interfaces for wired or wireless connections. The constituent instructions may be received through the network interface 160. Information associated with the call function may be received or transmitted through the network interface 160.

Also, according to other example embodiments, the computer system 100 may include a more number of components than the components of FIG. 1. However, most of conventional components are not illustrated for brivity. For example, the computer system 100 may include at least a portion of I/O devices connected to the I/O interface 150, or may further include other components, for example, a transceiver, a global positioning system (GPS) module, a camera, a variety of sensors, and/or a database. For example, if the computer system 100 is configured in a form of a mobile device, for example, a smartphone, the computer system 100 may be configured to further include various components, for example, a camera, an acceleration sensor or a gyro sensor, a camera, various types of buttons, a button using a touch panel, an I/O port, and/or a vibrator for vibration, which are generally included in the mobile device.

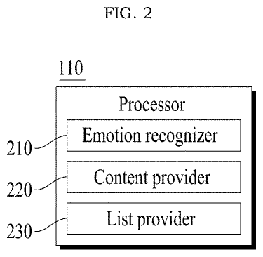

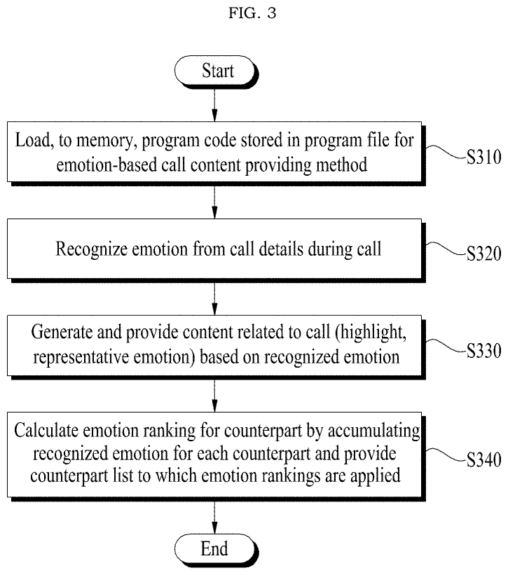

FIG. 2 is a diagram illustrating an example of components includable in a processor of a computer system according to at least one example embodiment, and FIG. 3 is a flowchart illustrating an example of an emotion-based call content providing method performed by a computer system according to at least one example embodiment.

Referring to FIG. 2, the processor 110 may include an emotion recognizer 210, a content provider 220, and a list provider 230. Such components of the processor 110 may be representations of different functions performed by the processor 110 in response to a control instruction provided from at least one program code. For example, the emotion recognizer 210 may be used as a functional representation for the processor 110 to control the computer system 100 to recognize an emotion during a call. The processor 110 and the components of the processor 110 may perform operations S310 to S340 included in the emotion-based call content providing method of FIG. 3. For example, the processor 110 and the components of the processor 110 may be configured to execute instructions according to at least one program code and a code of an OS included in the memory 120. Here, the at least one program code may correspond to a code of a program configured to process the emotion-based call content providing method.

The emotion-based call content providing method may not be performed in the order illustrated in FIG. 3. A portion of operations may be omitted or an additional process may be further included in the emotion-based call content providing method.

Referring to FIG. 3, in operation S310, the processor 110 may load, to the memory 120, a program code stored in a program file for the emotion-based call content providing method. For example, the program file for the emotion-based call content providing method may be stored in the permanent storage device 130 of FIG. 1. The processor 110 may control the computer system 100 such that the program code may be loaded to the memory 120 from the program file stored in the permanent storage device 130 through the bus 140. Here, the emotion recognizer 210, the content provider 220, and the list provider 230 included in the processor 110 may be different functional representations of the processor 110 to perform operations S320 to S340, respectively, by executing instructions of corresponding parts in the program code loaded to the memory 120. To perform operations S320 to S340, the processor 110 and the components of the processor 110 may directly process an operation or control the computer system 100 in response to a control instruction.

In operation S320, the emotion recognizer 210 may recognize an emotion from call details during a call. Here, the call details may include at least one of a voice and a video exchange between a user and a counterpart during the call. The emotion recognizer 210 may recognize an emotion of at least one of the user and the counterpart from the call details exchanged between the user and the counterpart. An emotion of the user may be recognized using at least one of a voice and a video of a user side that are directly input through an input device (e.g., a microphone or a camera) included in the computer system 100. An emotion of the counterpart may be recognized using at least one of a voice and a video of a counterpart side that are received from a device (not shown) of the counterpart through the network interface 160. A process of recognizing an emotion is further described below.

In operation S330, the content provider 220 may generate and provide content related to the call based on the recognized emotion. For example, the content provider 220 may store at least a portion of call details as highlight content based on an intensity (magnitude) of emotion recognized from the call details. Here, the highlight content may include a partial section of at least one of a voice and a video corresponding to the call details. For example, the content provider 220 may store, as a main scene of a corresponding call, a video corresponding to a section at which an emotion with a highest intensity is recognized during the call. Here, the content provider 220 may generate the highlight content using at least one of a voice and a video of the user side based on an emotion of the counterpart, or may generate the highlight content using at least one of a voice and a video of the counterpart side based on an emotion of the user. The highlight content may be generated by further using at least one of a voice and a video of an opposite side. For example, the content provider 220 may generate, as the highlight content, a video call scene of both sides having caused a highest intensity of emotion to the counterpart or a video call scene of both sides having caused a highest intensity of emotion to the user during a video call. As another example, the content provider 220 may select a representative emotion based on an appearance frequency or intensity for each emotion recognized from call details, and may generate and provide content corresponding to the representative emotion. For example, the content provider 220 may select, as a representative emotion of a corresponding call, an emotion that is most frequently recognized during the call and may display an icon that represents the representative emotion on a call history. Here, the content provider 220 may generate the icon representing the representative emotion based on an emotion of the user.

In operation S340, the list provider 230 may calculate an emotion ranking for a counterpart by accumulating the recognized emotion for each counterpart and may provide a counterpart list which includes identifications (e.g., name) of counterparts and emotion rankings associated therewith. Here, the list provider 230 may calculate an emotion ranking for a counterpart based on the emotion of the user recognized during the call. For example, the list provider 230 may calculate an emotion ranking for a counterpart for each type of an emotion and may provide a counterpart list based on an emotion ranking of a type corresponding to (or selected in response to) a user request. As another example, the list provider 230 may calculate an emotion value for a corresponding counterpart by classifying a desired (or alternatively, predetermined) type of an emotion (e.g., a positive emotion such as warm, happy, laugh, and sweet) among emotions recognized during a call per call with the counterpart and by summing or adding highest emotion intensities among the classified emotions, and may provide a counterpart list in which counterparts are sorted in descending order or ascending order based on an emotion value for each counterpart. As another example of a method of calculating an emotion value for each counterpart, an intensity of a most frequently recognized emotion among emotions recognized during a call may be accumulated.

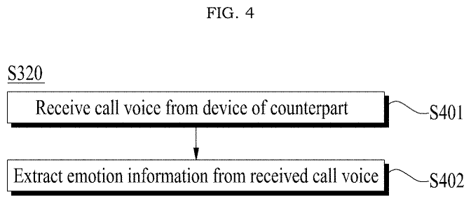

FIG. 4 is a flowchart illustrating an example of a process of recognizing an emotion from a voice according to at least one example embodiment.

Referring to FIG. 4, in operation S401, the emotion recognizer 210 may receive a call voice from a device of a counterpart through the network interface 160. That is, the emotion recognizer 210 may receive a voice input according to an utterance of the counterpart from the device of the counterpart during the call.

In operation S402, the emotion recognizer 210 may recognize an emotion of the counterpart by extracting emotion information from the call voice received in operation S401. The emotion recognizer 210 may acquire a sentence corresponding to the voice through a speech to text (STT), and may extract emotion information from the sentence. Here, the emotion information may include an emotion type and emotion intensity. Terms representing emotions, that is, emotional terms may be determined in advance, may be classified into a plurality of emotion types (e.g., joy, sadness, surprise, worry, suffer, anxiety, fear, detest, and anger.), and may be classified into a plurality of intensity classes (e.g., 1 to 10) based on a strength and weakness of each emotional term. Here, the emotional terms may include a specific word representing an emotion and a phrase or a sentence including the specific word. For example, a word such as “like” or “painful” or a phrase or a sentence such as “really like” may be included in the range of emotional terms. For example, the emotion recognizer 210 may extract a morpheme from a sentence according to a call voice of the counterpart, may extract a desired (or alternatively, predetermined) emotional term from the extracted morpheme, and may classify an emotion type and an emotion intensity corresponding to the extracted emotional term. The emotion recognizer 210 may divide a voice of the counterpart based on a desired (or alternatively, predetermined) section unit (e.g., 2 seconds), and may extract emotion information for each section. Here, if a plurality of emotional terms is included in a voice of a single section, a weight may be calculated based on an emotion type and an emotion intensity of each corresponding emotional term, and an emotion vector about emotion information may be calculated based on the weight. In this manner, emotion information representing the voice of the corresponding section may be calculated. In some example embodiments, the emotion information may be extracted based on at least one of voice tone information and voice tempo information.

Accordingly, the emotion recognizer 210 may recognize an emotion from the voice of the counterpart during the call. Although it is described that the emotion of the counterpart is recognized, an emotion of the user may also be recognized from a voice of the user side in the aforementioned manner.

The emotion information extraction technology described above with reference to FIG. 4 is provided as an example only and other known techniques may also be applied.

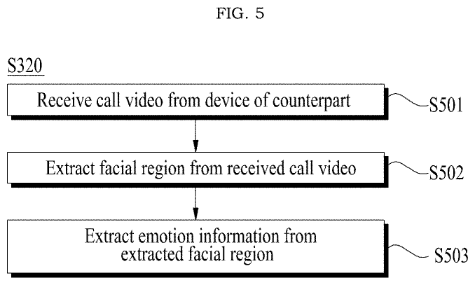

FIG. 5 is a flowchart illustrating an example of a process of recognizing an emotion from a video according to at least one example embodiment.

Referring to FIG. 5, in operation S501, the emotion recognizer 210 may receive a call video from a device of a counterpart through the network interface 160. That is, the emotion recognizer 210 may receive a video in which a face of the counterpart is captured from the device of the counterpart during a call.

In operation S502, the emotion recognizer 210 may extract a facial region from the call video received in operation S501. For example, the emotion recognizer 210 may extract the facial region from the call video based on adaptive boosting (AdaBoost) or skin tone information. Further, other known techniques may be applied.

In operation S503, the emotion recognizer 210 may recognize an emotion of the counterpart by extracting emotion information from the facial region extracted in operation S502. The emotion recognizer 210 may extract emotion information including an emotion type and an emotion intensity from a facial expression based on the video. The facial expression may be caused by contraction of facial muscles occurring in response to a deformation of facial elements, such as eyebrows, eyes, nose, lips, and skin. The intensity of facial expression may be determined based on a geometrical change in facial features or a density of muscle expression. For example, the emotion recognizer 210 may extract a region of interest (ROI) (e.g., an eye region, an eyebrow region, a nose region, or a lip region) for extracting a feature according to a facial expression, may extract a feature point from the ROI, and may determine a feature value based on the extracted feature point. The feature value corresponds to a specific numerical value representing a facial expression of a person based on a distance between feature points. To apply the determined feature value to an emotional sensitivity model, the emotion recognizer 210 determines an intensity value based on a numerical value of each feature value included in the video and determines an intensity value that matches a numerical value of each feature value by referring to a prepared mapping table. The mapping table is provided, for example, in advance based on the emotional sensitivity model. The emotion recognizer 210 may map the intensity value to the emotional sensitivity model and may extract a type and an intensity of emotion based on a result of applying the corresponding intensity value to the emotional sensitivity model.

Accordingly, the emotion recognizer 210 may recognize the emotion from the video of the counterpart during the call. Although it is described that the emotion of the counterpart is described, an emotion of the user may be recognized from a video of a user side in the aforementioned manner.

The emotion information extraction technology described above with reference to FIG. 5 is provided as an example only. Other known techniques may also be applied.

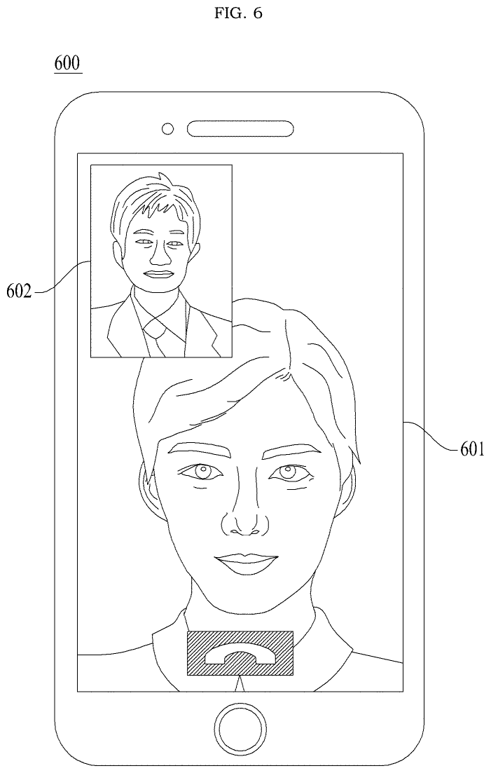

FIGS. 6 to 9 illustrate examples of describing a process of providing highlight content according to at least one example embodiment.

FIG. 6 illustrates an example of a call screen with a counterpart, that is, a video call screen 600 through which a video and a voice are exchanged. The video call screen 600 provides a counterpart-side video 601 as a main screen and also provides a user-side face video 602 on one region.

For example, the emotion recognizer 210 may recognize an emotion from a voice of a counterpart during a call, and the content provider 220 may generate at least a portion of the video call as highlight content based on the emotion of the counterpart. Here, the highlight content may be generated by storing call details including the user-side face video 602 of a partial section during the call. As another example, the call details also including the counterpart-side video 601 may be stored.

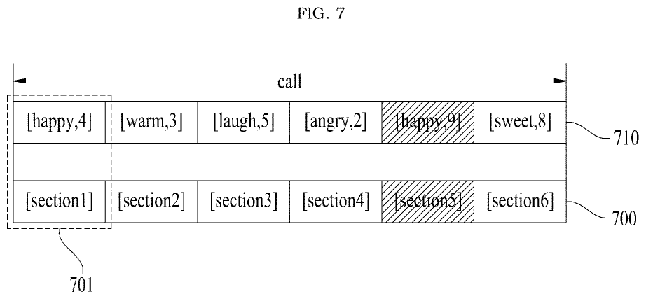

For example, referring to FIG. 7, once the call starts, the content provider 220 temporarily stores (e.g., buffers) call details 700 by a desired (or alternatively, predetermined) section unit (e.g., 2 seconds) 701. Here, the content provider 220 may compare an intensity of emotion 710 ([emotion type, emotion intensity]) recognized from the call details 700 of a corresponding section for each section unit, and when an intensity of emotion recognized from a recent section is determined to be greater than that of emotion recognized from a previous section, the content provider 220 may replace temporarily stored call details with call details of the recent section. According to the aforementioned method, the content provider 220 may acquire, as the highlight content, call details of a section from which an emotion with a highest intensity is recognized during the call. For example, referring to FIG. 7, among the entire sections of the call, [happy, 9] corresponds to the emotion with the highest intensity. Therefore, call details of a section [section 5] corresponds to the highlight content.

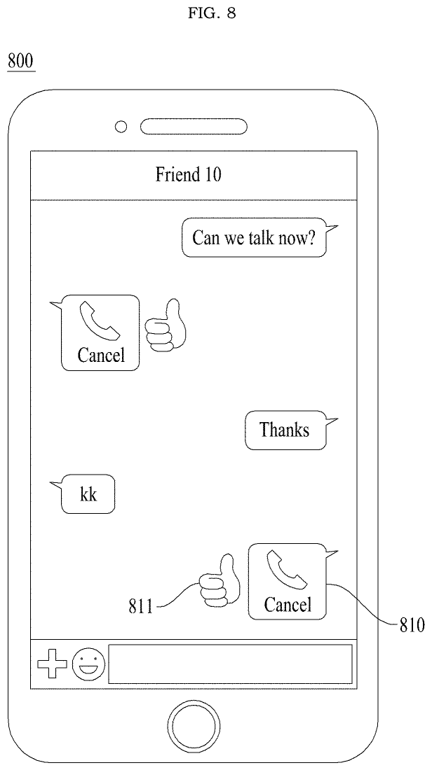

Once the call with the counterpart is terminated, the video call screen 600 of FIG. 6 may be switched to a chat interface screen 800 of FIG. 8 on which chat details with the corresponding counterpart is displayed.

The chat interface screen 800 may be configured as a chat-based interface and may collect and provide call details, such as a text, a video call, and a voice call, which are exchanged with the counterpart. Here, the content provider 220 may provide highlight content of a corresponding call for each call included in the call details. For example, once a call with a corresponding counterpart is terminated, the content provider 220 may provide a user interface (UI) 811 for playing highlight content of the corresponding call for a call-by-call item 810 on the chat interface screen 800.

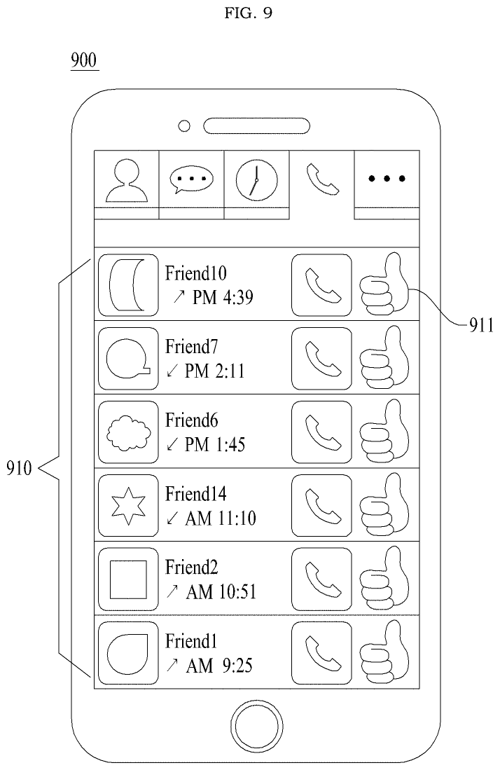

As another example, referring to FIG. 9, the content provider 220 may also provide highlight content through a call interface screen 900 for collecting and providing call details of a video call or a voice call. The call interface screen 900 may include a counterpart list 910 of counterparts having a call history with a user. Here, the content provider 220 may provide a user interface 911 for playing highlight content in a most recent call with a corresponding counterpart on an item corresponding to each counterpart included in the counterpart list 910.

Further, in the case of highlight content, the content provider 220 may provide a function capable of sharing a variety of media (e.g., a messenger, a mail, a message, etc.) with another user. The content provider 220 may generate call details corresponding to a highest intensity of emotion during the call as the highlight content and may share the highlight content with another user in a content form.

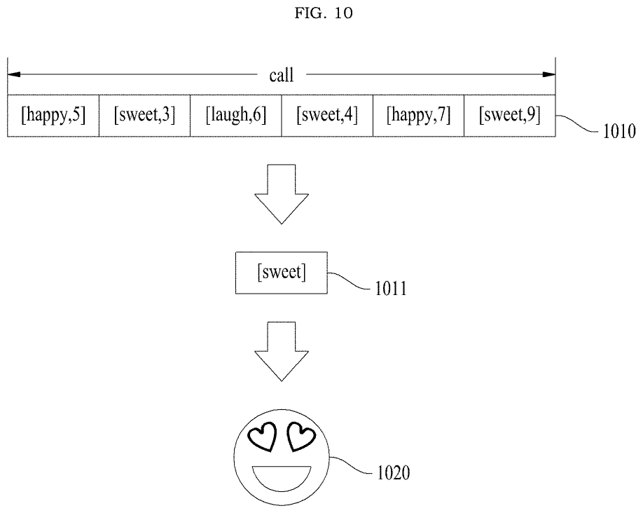

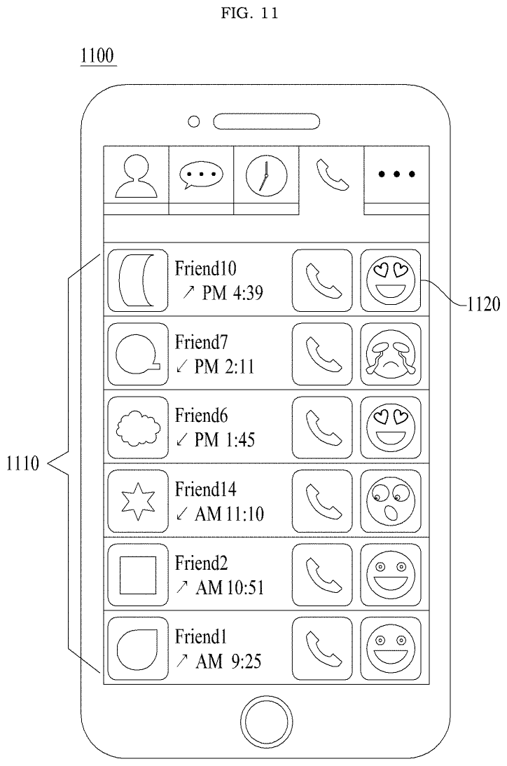

FIGS. 10 and 11 illustrate examples of describing a process of providing content corresponding to a representative emotion according to at least one example embodiment.

The emotion recognizer 210 may recognize an emotion from a voice of a user during a call with a counterpart, and the content provider 220 may determine a representative emotion of the corresponding call based on an appearance frequency or intensity for each emotion during the call, and may provide content corresponding to the representative emotion.

Referring to FIG. 10, once a call starts, the emotion recognizer 210 may recognize an emotion from a voice of each section based on a desired (or alternatively, predetermined) section unit (e.g., 2 seconds). The content provider 220 may determine, as a representative emotion 1011, an emotion that is most frequently recognized among emotions 1010 recognized from the entire call sections, and may generate an icon 1020 corresponding to the representative emotion 1011 as content related to the corresponding call. Here, the icon 1020 may include an emoticon, a sticker, an image, etc., representing an emotion. Instead of determining an emotion having a highest appearance frequency as a representative emotion, a highest intensity of emotion across the entire section may be determined as the representative emotion. In some example embodiments, values of emotion intensity may be summed or added for each emotion type and an emotion having a greatest summed value may be determined as the representative emotion.

Once a call is terminated, the content provider 220 may provide a representative emotion of the call through an interface screen associated with the corresponding call. For example, referring to FIG. 11, the content provider 220 may display a representative emotion of a corresponding call through a call interface screen 1100 for collecting and displaying call details of a video call or a voice call. The call interface screen 1100 may include a counterpart list 1110 of counterparts having a call history with a user. Here, the content provider 220 may display an icon 1120 corresponding to a representative emotion that is determined from a most recent call with a corresponding counterpart on an item that represents each counterpart in the counterpart list 1110.

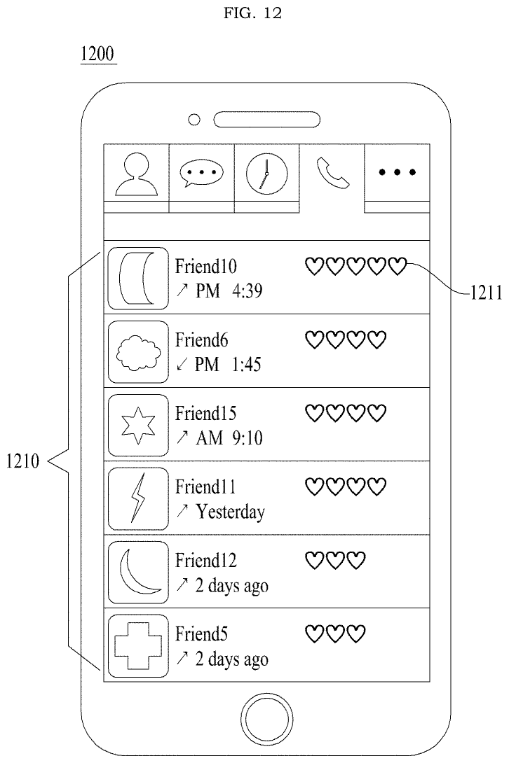

FIG. 12 illustrates an example of describing a process of providing a counterpart list to which emotion rankings are applied according to at least one example embodiment.

Referring to FIG. 12, the list provider 230 may provide an interface screen 1200 that includes a counterpart list 1210, which includes identifications (e.g., name) of counterparts and emotion rankings associated therewith, are applied in response to a request from a user. The list provider 230 may calculate an emotion ranking for a corresponding counterpart based on an emotion of the user recognized during a call. For example, the list provider 230 may calculate an emotion ranking based on an emotion value added for each counterpart by classifying a positive emotion (e.g., warm, happy, laugh, or sweet) among emotions recognized during a call per call with a corresponding counterpart and by summing or adding a highest emotion intensities among the classified emotions. The list provider 230 may provide the counterpart list 1210 in which counterparts are sorted in descending order or in ascending order based on an emotion value for each counterpart. Here, the list provider 230 may also display evaluation information 1211 representing an emotion value about a corresponding counterpart on an item that represents each counterpart in the counterpart list 1210.

The list provider 230 may calculate an emotion ranking for each emotion type, and may provide the counterpart list 1210 based on an emotion ranking of a type selected by the user in addition to emotion rankings desired (or alternatively, predetermined) about emotions.

Therefore, herein, it is possible to recognize an emotion from call details during a call, and to provide content (e.g., highlight content or representative emotion icon) related to the call based on the emotion recognized from the call details or to provide a counterpart list to which emotion rankings are applied.

As described above, according to some example embodiment, it is possible to recognize an emotion during a call, to generate and use content related to the call based on the recognized emotion, and to provide various user interfaces or fun elements associated with the call.

The systems or apparatuses described above may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors, distributed processors, a cloud computing configuration, etc. Moreover, each processor of the at least one processor may be a multi-core processor, but the example embodiments are not limited thereto.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above-described example embodiments may be recorded in non-transitory computer-readable media including program instructions to implement various operations of the above-described example embodiments. The media may also include, alone or in combination with the program instructions, data files, data structures, and the like. The media may continuously store a program executable by a computer or may temporarily store or the program for execution or download. Also, the media may be various types of recording devices or storage devices in which a single piece or a plurality of pieces of hardware may be distributed over a network without being limited to a medium directly connected to a computer system. Examples of the media may include magnetic media such as hard disks, floppy disks, and magnetic tapes; optical media such as CD-ROM discs and DVDs; magneto-optical media such as floptical disks; and hardware devices that are specially configured to store and perform program instructions, such as read-only memory (ROM), random access memory (RAM), flash memory, and the like. Examples of other media may include recording media and storage media managed at Appstore that distributes applications or sites and servers that supply and distribute various types of software. Examples of program instructions include both machine code, such as produced by a compiler, and files containing higher level code that may be executed by the computer using an interpreter.

While this disclosure includes some specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A computer-implemented emotion-based call content providing method comprising:
recognizing an emotion from call details during a call between a user and a counterpart;
storing at least a portion of the call details; and
providing the at least a portion of the call details as first content related to the call based on the recognized emotion.

2. The method of claim 1, wherein the recognizing comprises recognizing the emotion using at least one of a video and a voice exchanged between the user and the counterpart.

3. The method of claim 1, wherein the recognizing comprises recognizing the emotion about at least one of the user and the counterpart from the call details.

4. The method of claim 1, wherein
the recognizing comprises recognizing an emotion intensity for each section of the call, and
the providing comprises storing, as highlight content, call details of a specific section from which a specific emotion with a highest intensity is recognized among entire sections of the call.

5. The method of claim 4, wherein the providing comprises providing the highlight content through an interface screen associated with the call.

6. The method of claim 4, wherein the providing comprises providing a function of sharing the highlight content with another user.

7. The method of claim 1, further comprising:
selecting a representative emotion based on at least one of an emotion type and an intensity of the recognized emotion and providing second content corresponding to the representative emotion.

8. The method of claim 7, wherein the providing second content corresponding to the representative emotion comprises:
selecting a first emotion corresponding to a highest appearance frequency or a highest emotion intensity as the representative emotion, or
summing values of an emotion intensity for each emotion type and selecting a second emotion having a largest summed value as the representative emotion.

9. The method of claim 7, wherein the providing second content corresponding to the representative emotion comprises displaying an icon representing the representative emotion through an interface screen associated with the call.

10. The method of claim 1, further comprising:
calculating an emotion ranking for each counterpart by accumulating the recognized emotion therefor, and providing a counterpart list including identifications of counterparts and emotion rankings associated therewith.

11. The method of claim 10, wherein the providing a counterpart list comprises calculating the emotion ranking for each counterpart by summing an intensity of emotion corresponding to an emotion type among a plurality of emotions recognized with respect to the call.

12. The method of claim 10, wherein the providing a counterpart list comprises calculating the emotion ranking for each counterpart with respect to each emotion type and providing the counterpart list according to the emotion ranking of a specific emotion type selected based on a user request.

13. A non-transitory computer-readable storage medium storing a computer program, when executed by a computer, to cause the computer to perform an emotion-based call content providing method, wherein the emotion-based call content providing method comprises:
recognizing an emotion from call details during a call between a user and a counterpart;
storing at least a portion of the call details; and
providing the at least a portion of the call details as content related to the call based on the recognized emotion.

14. A computer-implemented emotion-based call content providing system comprising:
at least one processor configured to execute computer-readable instructions to recognize an emotion from call details during a call between a user and a counterpart,
store at least a portion of the call details, and
provide the at least a portion of the call details as content related to the call based on the recognized emotion.

15. The system of claim 14, wherein the at least one processor is configured to recognize the emotion about at least one of the user and the counterpart from the call details using at least one of a video and a voice exchanged between the user and the counterpart.

16. The system of claim 14, wherein the at least one processor is configured to,
recognize an emotion intensity for each section of the call, and
store, as highlight content, call details of a specific section from which a specific emotion with a highest intensity is recognized among entire sections of the call.

17. The system of claim 14, wherein the at least one processor is configured to select a representative emotion based on at least one of a type and an intensity of the recognized emotion and provide content corresponding to the representative emotion.

18. The system of claim 17, wherein the at least one processor is configured to perform,
selecting a first emotion corresponding to a highest appearance frequency or a highest emotion intensity as the representative emotion, or
summing a value of an emotion intensity for each emotion type and selecting a second emotion having a largest summed value as the representative emotion.

19. The system of claim 14, wherein the at least one processor is configured to calculate an emotion ranking for each counterpart by accumulating the recognized emotion therefor, and provide a counterpart list including identifications of counterparts and emotion rankings associated therewith.

20. The system of claim 19, wherein the at least one processor is configured to calculate the emotion ranking for each counterpart by adding an intensity of emotion corresponding to an emotion type among a plurality of emotions recognized with respect to the call.
